(19) United States
(12) Patent Application Publication
(10) Pub. No.: US 2013/0160922 A1
(43) Pub. Date: Jun. 27, 2013

(54) METHOD AND APPARATUS FOR EQUIPPING BOTTLES

(71) Applicant: Michael Zwilling, Hamm (DE)

(72) Inventor: Michael Zwilling, Hamm (DE)

(73) Assignee: KHS GmbH, Dortmund (DE)

(21) Appl. No.: 13/821,058

(22) PCT Filed: Sep. 9, 2011
(86) PCT No.: PCT/EP2011/004555

§ 371 Date: Mar. 6, 2013

(30) Foreign Application Priority Data
Sep. 17, 2010 (DE) 10 2010 045 661.6

(51) Int. Cl. B65C 3/16; B65C 9/00; B65C 9/40

(52) U.S. Cl. CPC B65C 3/16; B65C 9/40; B65C 9/00
USPC 156/60; 156/378; 156/556

(57) ABSTRACT

A method for equipping bottles with equipment elements using a group of at least three similar container-equipping subassemblies designed to apply equipment elements to a container region of containers moving, on a transporting system, past the container-equipping subassemblies includes, during disruption-free operation, activating at least two container-equipping subassemblies of the group to equip in each case one container that has not yet been labeled by another container-equipping subassembly of the group, and during disruption-free operation, placing at least one container-equipping subassembly assigned to the group in standby mode, and in the event of disruption to a first activated container-equipping subassembly in the group, activating the container-equipping subassembly that is in standby mode to take over the function of the first container-equipping subassembly.

The invention relates to a method according to the preamble of claim 1 or 2 and to an apparatus according to the preamble of claim 8 or 9.

In the context of the invention, equipment elements are elements which are applied to the containers as information and/or advertisement carriers and/or as information and/or advertisement elements or notices and/or in order to create proof of guarantee and/or originality and/or in order to create a desired optical appearance of the container. In this context, equipment elements are in particular labels, sleeves, foil wraps, but also printed images etc. applied to the containers, but also inter alia printing subassemblies.

In the context of the invention, container-equipping subassemblies are subassemblies for applying equipment elements to bottles or similar containers. In this context, container-equipping subassemblies are in particular labelling subassemblies for applying labels, sleeves, foil wraps, etc. to bottles or similar containers.

In the context of the invention, similar container-equipping subassemblies are container-equipping subassemblies which equip the containers preferably with similar or identical equipment elements in each case at one and the same container region and in one and the same way and/or location and/or orientation, wherein these container-equipping subassemblies may be structurally different but are preferably structurally identical or substantially identical.

In the context of the invention, disruptions to operation are generally breaks in operation of the respective container-equipping subassembly, for example due to actual disruptions in the subassembly, due to an emptying or lack or shortage of equipment elements, for example of labels in the subassembly, due to reloading or refilling of the container-equipping subassembly with equipment elements or equipment material, etc.

In the context of the invention, the expression “substantially” means deviations of +/−10%, preferably +/−5%, from the exact value in each case, and/or deviations in the form of changes which do not affect the function.

Methods for labelling bottles or other containers and associated container-equipping subassemblies in the form of labelling subassemblies are known, namely in different embodiments. Also known in particular are labelling subassemblies for so-called ROLLFED labelling, in which the labels provided with an application of glue in each case and cut for example from a strip-like label material in the subassembly are transferred to the respective container, which is moved past the labelling subassembly on a transporting system (e.g. rotor), and in the process are applied by rolling onto said container as the latter rotates about its vertical axis.

In order to increase the output, it is also known (EP 1 449 778 A1) to provide, on a rotor which can be driven in rotation about a vertical machine axis and on the peripheral region of which a plurality of treatment positions for holding in each case one container are formed in a manner offset at uniform angular spacings around the machine axis, a plurality of container-equipping subassemblies in the form of labelling subassemblies which do not move with the rotor. The labelling subassemblies are in this case operated in such a way that each subassembly serves to label a container which is moved past it and which has not already been labelled by another labelling subassembly or will not subsequently be labelled by another subassembly. Given a number of n labelling subassemblies, only every n^{th} container is labelled by each labelling subassembly. The subassembly output of each labelling subassembly (number of transferred equipment elements or labels per unit time) can therefore be reduced by the factor 1/n for a predefined machine output of the labelling machine (number of labelled containers per unit time) or, conversely, for a predefined maximum output of the labelling subassemblies, the output of the labelling machine can be significantly increased. One disadvantage with known labelling machines of this type is inter alia that, in the event of a disruption in just one labelling subassembly, the entire labelling machine is stopped, and the likelihood of disruption and thus of stoppage of the labelling machine multiplies according to the number of labelling subassemblies. In order to avoid breaks in the labelling operation and thus disruptions to the system as a whole, it is therefore often also customary to operate two labelling machines in parallel.

The object of the invention is to provide a method which allows an equipping, in particular also a labelling or printing, of containers that is as disruption-free or as stoppage-free as possible with a high machine output and a nevertheless reduced subassembly output of the activated container-equipping subassemblies, e.g. labelling subassemblies or printing subassemblies. In order to achieve this object, a method is configured according to claim 1 or 2. An apparatus for carrying out the method forms the subject matter of claim 8 or 9.

In one embodiment of the invention, in order to apply an equipment element to one and the same container region and in one and the same location and/or orientation, at least three container-equipping subassemblies are provided, of which, during normal or disruption-free operation, at least two container-equipping subassemblies are activated or equip the containers, while at least one container-equipping subassembly is in a non-activated state or in a standby state or mode and, in the event of a failure of or disruption to one of the activated container-equipping subassemblies, is activated to take over the function of this disrupted subassembly. The equipping of the containers is split between the at least two activated container-equipping subassemblies in such a way that each activated container-equipping subassembly equips only those containers which have not already been equipped by another container-equipping subassembly of the same group of container-equipping subassemblies (container-equipping-subassembly group) to which at least the activated container-equipping subassemblies, but preferably also the container-equipping subassembly that is in the non-activated state or in the standby mode, belong. Given a number of n activated container-equipping subassemblies of the container-equipping-subassembly group, each subassembly equips in each case only the n^{th} container that is moved past it, so that, for a predefined subassembly output (number of transferred equipment elements per unit time), a high machine output (number of equipped containers per unit time) is possible.

In a further embodiment of the method according to the invention, during normal, disruption-free operation, all the container-equipping subassemblies of the respective container-equipping-subassembly group are activated, namely once again in such a way that, in the case of a number of n container-equipping subassemblies, each subassembly equips only those containers which have not already been provided with an equipment by another container-equipping subassembly of the same container-equipping-subassembly group, wherein once again each container-equipping subassembly equips in each case only the n^{th} container moved past it. In the event of disruptions to an activated container-equipping subassembly, at least one non-disrupted, activated container-equipping subassembly takes over the function of the disrupted subassembly, namely with an increase in its subassembly output and/or a reduction in the machine output.

The non-labelled containers which arrive during the changeover from the disrupted container-equipping subassembly to the container-equipping subassembly activated from the standby mode and/or during the takeover of the function of the disrupted container-equipping subassembly by at least one non-disrupted container-equipping subassembly are again moved past the container-equipping subassemblies for equipping purposes, namely for example in that these containers to this end remain on the transporting system or are ejected from the transporting system and fed back to the latter.

The invention offers inter alia the advantage that, even with a high machine output, for example with a machine output in the region of 50,000 equipped or labelled containers per hour or above, a break in operation in the event of disruptions occurring in a container-equipping subassembly or labelling subassembly is effectively avoided.

Another advantage of the invention lies inter alia in that the second labelling machine that is often required, as well as the additional transporters required for this, can be omitted, which means not only a cost saving but in particular also a reduction in the amount of space required and in the operating, maintenance and control effort.

Further developments, advantages and possible uses of the invention will become apparent from the following description of examples of embodiments and from the figures. All the features described and/or shown in the figures, per se or in any combination, form in principle the subject matter of the invention, regardless of the way in which they are combined or refer back to one another in the claims. The content of the claims also forms part of the description.

The invention will be explained in more detail below with reference to the figures and based on the example of a machine designed as a labelling machine for equipping containers by labelling. In the figures:

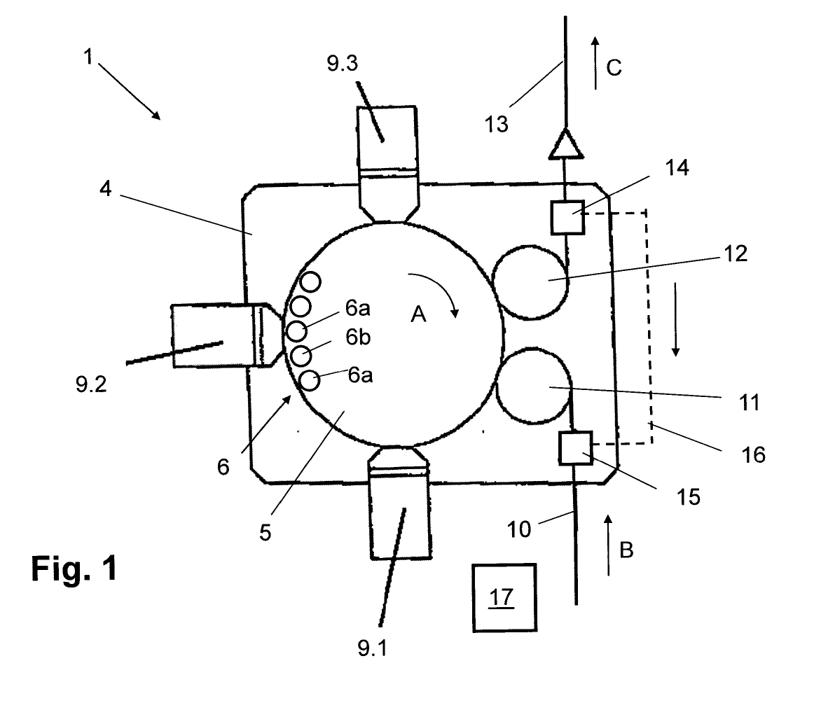

FIG. 1 shows the labelling machine in a simplified schematic diagram and in plan view;

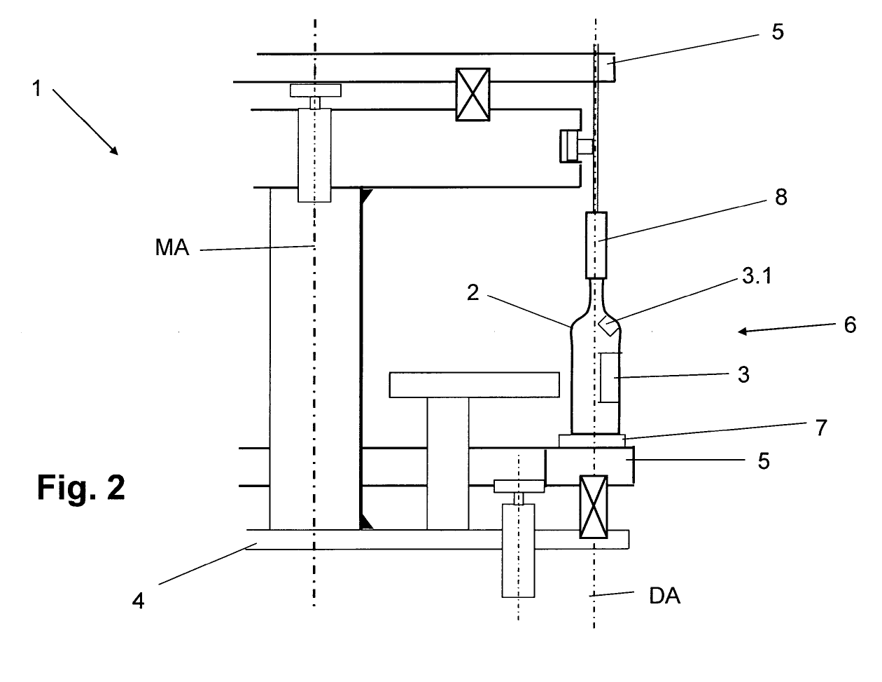

FIG. 2 shows, in a schematic diagram, one of the treatment positions of the labelling machine together with a container in the form of a bottle which has already been labelled and is arranged at said treatment position.

In the figures, 1 denotes a labelling machine of the rotary type for labelling containers in the form of bottles 2, i.e. for applying equipment elements in the form of labels 3 to a predefined region of the bottles 2, namely in the illustrated embodiment to a trunk region of the bottles 2 which is of circular cylindrical shape.

The labelling machine 1 comprises inter alia a rotor 5 which is mounted on a machine frame 4 such as to be able to rotate about a vertical machine axis MA and which is driven in rotation in the direction of the arrow A around the machine axis MA, and on the periphery of which a plurality of treatment positions 6 are formed in a manner offset from one another at uniform angular spacings around the machine axis MA. Each treatment position 6 comprises inter alia a container carrier which is configured as a bottle plate 7 and which in the illustrated embodiment is able to rotate or swivel in a controlled manner about a swivel axis or rotation axis DA parallel to the machine axis MA and forms a standing surface for the respective bottle 2, and a plunger 8 which can be raised and lowered in a controlled manner in the axis DA and which, during the labelling process, clamps the bottle 2 between said plunger and the bottle plate 7, said bottle standing with its base on the bottle plate 7 and being arranged with its bottle axis coaxial to the axis DA.

Provided on the movement path of the treatment positions 6 are three container-equipping subassemblies in the form of labelling subassemblies 9.1, 9.2 and 9.3 which do not move with the treatment positions or with the rotor 5 and which are configured identically at least with regard to their function so that they each apply the same labels 3 to one and the same container region and in one and the same location and orientation.

With regard to the respective labelling method, the labelling subassemblies 9.1-9.3 may be configured differently, for example for labelling the bottles 2 with labels 3 which have been removed as individual labels from a label magazine comprising many labels provided with a glue application, for labelling the bottle 2 with labels 3 which have been cut from a strip-like label material and provided with a glue application, for labelling the bottle 2 with self-adhesive labels, etc., but wherein all the labelling subassemblies 9.1-9.3 are configured as a labelling-subassembly group in each case for one and the same labelling method, for example including for so-called ROLLFED labelling, in which the respective label 3 provided with a glue application is applied to the relevant bottle 2 with a front end relative to the feed direction or conveying direction of said label and then is rolled onto the bottle 2 as the latter rotates about its axis.

The bottles 2 to be labelled are fed into the labelling machine 1 via an external transporter 10 as a single-lane stream of containers (arrow B) and in each case pass via a container inlet 11 to one of the treatment positions 6. The labelled bottles 2 are removed from the treatment positions 6 at a container outlet 12 and are conveyed onwards to an external transporter 13 for transporting (arrow C) said bottles away from the labelling machine 1.

During normal, disruption-free operation, the labelling of the bottles 2 takes place using two labelling subassemblies, for example using the labelling subassemblies 9.1 and 9.2, i.e. only these two labelling subassemblies are activated, while the third labelling subassembly, for example the labelling subassembly 9.3, is in a standby mode. In detail, during normal, disruption-free operation, the activated labelling subassemblies, for example the labelling subassemblies 9.1 and 9.2, are driven in synchronism with the rotational movement of the rotor 5, namely in such a way that for example the labelling subassembly 9.1 labels only those bottles 2 that are arranged at the treatment positions 6 additionally denoted 6a, and the labelling subassembly 9.2 labels only those bottles 2 that are arranged at the treatment positions 6 additionally denoted 6b. The treatment positions 6 denoted 6a and 6b are each of identical design and are provided on the periphery of the rotor 5 in such a way that, for example in the direction of rotation A of the rotor 5, each treatment position 6 denoted 6a is followed by a treatment position 6 denoted 6b and the latter is in turn followed by a treatment position 6 denoted 6a. Due to the described assignment of the labelling subassemblies 9.1 and 9.2 to the treatment positions 6 denoted 6a and 6b respectively, i.e. due to the fact that in each case only every second bottle 2 moving past the relevant labelling subassembly 9.1 or 9.2 is labelled, a significant increase in the machine output of the labelling machine 1 is possible, in particular including in the case of ROLLFED labelling.

In the event of a break in operation in one of the activated labelling subassemblies, for example in the labelling subassembly 9.1 or 9.2 as a result of a disruption or as a result of a lack of labels 3, the labelling subassembly that was until now not activated and was in the standby mode, for example the labelling subassembly 9.3, automatically takes over the function of the stopped or disrupted labelling subassembly, for example the function of the labelling subassembly 9.1 for labelling the bottles 2 arranged at the treatment positions 6 denoted 6a or the function of the stopped or disrupted labelling subassembly 9.2 for labelling the bottles 2 arranged at the treatment positions 6 denoted 6b.

The activation of the labelling subassembly that is in the standby mode takes place in such a way that this labelling subassembly is synchronised with the rotational movement of the rotor 5 and is placed relative to the rotor 5 in such a way that this labelling subassembly then labels those bottles 2 that are located at the treatment positions 6 assigned to the disrupted labelling subassembly.

It will be understood that, given a total of three labelling subassemblies 9.1-9.3, it is not necessarily the labelling subassembly 9.3 that is not activated during normal labelling operation but instead is in the standby mode, but rather any of the three labelling subassemblies 9.1-9.3 may be in this non-activated standby mode while the two other activated subassemblies label the bottle 2 respectively at every second treatment position 6.

It will also be understood that, in order to further increase the machine output at a predefined subassembly output, it is also possible to provide more than three labelling subassemblies for applying the labels 3 to one and the same region of the bottles 2, wherein said labelling subassemblies then once again form a group and are operated in such a way that one labelling subassembly is not activated or is in the standby mode and n labelling subassemblies are activated. The activated labelling subassemblies in each case label the bottles 2 arranged at every n^{th} treatment position 6. In the event of operation being disrupted in one of the activated labelling subassemblies, the function thereof is once again automatically taken over by the labelling subassembly that is in the standby mode.

Instead of the above-described mode of operation of the labelling subassemblies 9.1-9.3, in which at least one labelling subassembly is in the standby mode during normal, disruption-free operation, a mode of operation is also possible in which, during normal, disruption-free operation, all the labelling subassemblies 9.1-9.3 are activated so that a further increase in the machine output of the labelling machine 1 is achieved with a predefined subassembly output of the labelling subassemblies 9.1-9.3. In the event of a disruption in one of the labelling subassemblies 9.1-9.3, the function thereof is then taken over by at least one of the activated, non-disrupted labelling subassemblies, namely with an increase in the subassembly output thereof and/or with a reduction in the machine output of the labelling machine 1.

Compared to the mode of operation described above, this mode of operation has the additional advantage that, when a disruption to operation occurs in one of the labelling subassemblies 9.1-9.3, for a constant machine output of the labelling machine the labelling subassembly which takes over the function of the disrupted subassembly has to be accelerated only relatively slightly from its previous subassembly output to the increased output, whereas when activating the labelling subassembly that is in the standby mode an acceleration of this subassembly from zero to the subassembly output corresponding to the operating speed is required.

Also when there are more than three labelling subassemblies it is possible that, during normal, disruption-free operation, all the labelling subassemblies are activated for labelling the bottles 2 in order to achieve a further increase in the machine output at a predefined subassembly output. In the event of a disruption to operation or a break in a labelling subassembly, the function thereof is taken over by the other, activated labelling subassemblies with an increase in the subassembly output and/or a reduction in the machine output.

The bottles 2 which have not been provided with an equipment element or have not been labelled and which in the event of a disruption arrive during the changeover from the disrupted labelling subassembly to the labelling subassembly activated from the standby mode or in the event of a disruption arrive during the takeover of the function of the disrupted labelling subassembly by at least one non-disrupted labelling subassembly remain for example on the rotor 5 or at the relevant treatment position 6 and are again moved past a non-disrupted labelling subassembly by the rotor 5. The container inlet 11 and the container outlet 12 are to this end each designed with a controlled points-like function and/or barrier function which prevents ejection of the non-labelled bottles 2 at the container outlet 12 and allows these bottles to be moved past without disruption at the container inlet 11, namely without colliding with a bottle 2 fed via the container inlet 11 by the transporter 10. It is also possible that the bottles 2 not labelled during the changeover are ejected for example at a position 14 after passing the container outlet 12 and are introduced into the container stream at a position 15 upstream of or at the container inlet 11 for labelling at a non-disrupted labelling subassembly. The two positions 14 and 15 are connected to one another via a transport path 16 which is formed for example by at least one transport starwheel that cooperates with transport starwheels of the container inlet 11 and container outlet 12.

The above-described functions of the labelling machine 1 are controlled by control electronics denoted generally by 17 in FIG. 1.

If it is necessary to provide the bottles 2 with a respective label at a plurality of different regions, for example in addition to the label 3 also with a label 3.1 in the chest region, then a separate group of respectively similar labelling subassemblies comprising at least three labelling subassemblies is provided for each label 3 and 3.1 to be applied to the bottle 2, wherein the labelling subassemblies of each group are then operated in the manner described above.

In the above description of examples of embodiments, it has been assumed that the container-equipping subassemblies are labelling subassemblies for labelling the containers or bottles 2. In principle, the container-equipping subassemblies may also be subassemblies for creating other equipments or other equipment features, for example print heads for printing the containers 2.

### LIST OF REFERENCES

1 labelling machine
2 container or bottle
3, 3.1 label
4 machine frame
5 rotor
6 treatment position
7 bottle plate
8 plunger
9.1-9.3 labelling subassemblies
10 external transporter
11 container inlet
12 container outlet
13 external transporter
14 ejection position
15 introduction position
16 conveying path
17 control electronics
A direction of rotation of the rotor
B, C conveying direction of the external transporter 10 or 13, respectively
DA rotation axis or swivel axis of the container carrier or bottle plate 7
MA vertical machine axis

1-13. (canceled)

14. A method for equipping bottles with equipment elements using a group of at least three similar container-equipping subassemblies designed to apply equipment elements to one and the same container region of bottles moving, on a transporting system, past said container-equipping subassemblies, said method comprising during disruption-free operation, activating at least two container-equipping subassemblies of said group of at least three similar container-equipping subassemblies to equip in each case one bottle that has not yet been labeled by another container-equipping subassembly of said group of at least three similar container-equipping subassemblies, and during disruption-free operation, placing at least one container-equipping subassembly assigned to said group of at least three similar container-equipping subassemblies in standby mode, and in the event of disruption to a first activated container-equipping subassembly in said group of at least three similar container-equipping subassemblies, activating said at least one container-equipping subassembly that is in standby mode to take over the function of said first container-equipping subassembly.

15. The method of claim 14, further comprising providing, for each equipment element, a separate container-equipping-subassembly group comprising at least three similar container-equipping subassemblies for each equipment element.

16. The method of claim 14, further comprising causing bottles that lack said equipment element and that arrive during a changeover from said first activated container-equipping subassembly to said at least one container-equipping subassembly that is in standby mode to remain on said transport path and to again move past said container-equipping subassemblies for application of said equipment elements.

17. The method of claim 14, further comprising causing bottles that lack said equipment element and that arrive during a changeover from said first activated container-equipping subassembly to said at least one container-equipping subassembly that is in standby mode to be ejected from said transport path and to be fed back to said transport path to be equipped at a container-equipping subassembly.

18. The method of claim 14, further comprising, during normal, disruption-free operation, causing only an n^{th} bottle that moves past said container-equipping subassemblies to be provided with said equipment by each container-equipping subassembly of said container-equipping subassembly group, wherein n is a cardinality of container-equipping subassemblies activated during normal, disruption-free operation.

19. The method of claim 14, further comprising selecting said container-equipping subassemblies to include labeling subassemblies for labeling said bottles with equipment elements, said equipment elements including labels.

20. The method of claim 14, further comprising selecting said container-equipping subassemblies to include labeling subassemblies for labeling said bottles with equipment elements, said equipment elements including roll-fed labels.

21. The method of claim 14, further comprising selecting said container-equipping subassemblies to include printing subassemblies.

22. The method of claim 14, further comprising selecting said transporting system to include a rotor that can be driven to rotate about a vertical machine axis, said transporting system being configured on a peripheral region with a plurality of treatment positions, each of which holds one container.

23. A method for equipping bottles with equipment elements using similar container-equipping subassemblies that are configured to apply equipment elements to one and the same container region of bottles moving, on a transporting system, past said container-equipping subassemblies, said method comprising, during disruption-free operation, activating all container-equipping subassemblies of a container-equipping-subassembly group to equip in each case one container that has not yet been labeled by another container-equipping subassembly of said group, and, in response to a disruption of an activated container-equipping subassembly, causing at least one other container-equipping subassembly of said group to take over on behalf of said disrupted container-equipping subassembly with at least one of an increased subassembly output and a reduced machine output.

24. An apparatus for equipping bottles with equipment elements, said apparatus comprising a group of at least three similar container-equipping subassemblies configured to apply equipment elements to one and the same container region of bottles moving, on a transporting system, past said container-equipping subassemblies, wherein, during disruption-free operation, at least two container-equipping subassemblies of said group are activated to equip in each case one container that has not yet been equipped by another container-equipping subassembly of said group, and a controller configured to cause a container-equipping subassembly assigned to said group to be in standby mode during disruption free operation, and in response to detecting disruption of a first container-equipping subassembly in said group, to cause said container-equipping subassembly to transition from standby mode to operating mode to take over the function of said first container-equipping subassembly.

25. The apparatus of claim 24, further comprising, for equipping said bottles with in, each case, a plurality of equipment elements, a separate container-equipping-subassembly group comprising at least three similar container-equipping subassemblies for each equipment element.

26. The apparatus of claim 24, wherein said controller is configured to cause bottles that lack said equipment element and that arrive during a changeover from said first activated container-equipping subassembly to said container-equipping subassembly that is in standby mode to remain on said transport path and to again move past said container-equipping subassemblies for application of said equipment elements.

27. The apparatus of claim 24, wherein said controller is configured to cause bottles that lack said equipment element and that arrive during a changeover from said first activated container-equipping subassembly to said container-equipping subassembly that is in standby mode to be ejected from said transport path and to be fed back to said transport path to be equipped at a container-equipping subassembly.

28. The apparatus of claim 24, wherein said container-equipping subassemblies comprise labeling subassemblies for labeling the bottles with equipment elements, said equipment elements comprising labels.

29. The apparatus of claim 24, wherein said container-equipping subassemblies comprise printing subassemblies.

30. The apparatus of claim 24, wherein said transporting system comprises a rotor that can be driven to rotate about a vertical machine axis, and that is configured on a peripheral region with a plurality of treatment positions, each of which holds one bottle.

31. An apparatus for equipping bottles with equipment elements, said apparatus comprising a group of at least three similar container-equipping subassemblies that are configured to apply equipment elements to one and the same container region of bottles moving, on a transporting system, past said container-equipping subassemblies, wherein, during disruption-free operation, all container-equipping subassemblies of said group are activated to equip in each case one bottle that has not yet been labeled by another container-equipping subassembly of said group, and a controller configured for responding to a disruption to a first activated container-equipping subassembly by causing a second container-equipping subassembly of said group to take over the function of said first disrupted container-equipping subassembly with at least one of an increased subassembly output and a reduced machine output.
